(19) United States
(12) Patent Application Publication
(10) Pub. No.: US 2025/0305959 A1
(43) Pub. Date: Oct. 2, 2025

(54) OPTICAL ANALYSIS SYSTEMS AND METHODS

(71) Applicant: MGI Tech Co., Ltd., Shenzhen (CN)

(72) Inventors: Jose Manuel Alvarado Sasian, Tucson, AZ (US); Craig E. Uhrich, Mountain View, CA (US); Yakov Bobrov, Burlingame, CA (US); Matthew William Derstine, Los Gatos, CA (US)

(21) Appl. No.: 19/032,650

(22) Filed: Jan. 21, 2025

Related U.S. Application Data
(63) Continuation of application No. 18/619,460, filed on Mar. 28, 2024, now abandoned.

(51) Int. Cl. G01N 21/64; G01N 15/1434

(52) U.S. Cl. CPC G01N 21/6486; G01N 15/1436; G01N 21/6458

(57) ABSTRACT

Optical analysis systems and methods including optical elements positioned on opposite sides of an intermediate imaging plane to create anisotropic distortion associated with a non-linear scanning of an objective relative to a substrate including an analyte array in order to remove motion blurring and produce diffraction limited imaging.

### CROSS-REFERENCES TO RELATED APPLICATIONS

This application claims benefit and is a continuation of application Ser. No. 18/619,460, filed Mar. 28, 2024, the entire contents of which is incorporated herein by reference for all purposes.

### RELATED FIELDS

Blur correction for optical analysis systems and methods, in particular blur correction for optical analysis systems and methods involving non-linear scanning of an objective relative to a substrate surface that includes an analyte binding site array (e.g. nucleic acid binding sites).

### BACKGROUND

Nucleic acid sequencing and other analytic processes are often performed using complex, expensive, resource intensive systems. Improving the efficiency of such systems is an ongoing effort. Two key aspects of these systems are: (1) how quickly can the substrate be imaged, and (2) how densely can the analyte be arranged on the substrate.

Some currently available sequencing systems detect sequencing events by linearly scanning an objective of an optical detection system relative to a substrate such that the field of view of the objective is scanned over the substrate several times along parallel paths, with each pass imaging a portion of the substrate until the entire analyte array on the substrate is imaged. These linear scanning systems have the disadvantages of needing to slow, stop, re-position, and resume the relative movement of the objective relative to the substrate between the multiple straight path transits needed to image the entire analyte array. This leads to periods of time during the overall imaging process during which imaging of the substrate is not taking place due to the need to slow, stop, re-position, and resume scanning multiple times during the process.

Other systems have been contemplated that detect sequencing events on a rotating substrate as an objective is scanned in a spiral or other non-linear path relative to the substrate. Rotating systems may reduce or eliminate the need to slow, stop, re-position, and resume scanning multiple times during the process as is the case with linear scanning systems. However, rotational systems may cause other issues that are not present with linear scanning systems. For example, rotational systems may cause imaging blur due to the different angular velocities between analyte binding sites in the objective's field of view that are relatively closer to and farther away from the substrate's axis of rotation.

Previous efforts to address imaging blur in rotational systems leave room for improvement. For example, U.S. Pat. No. 10,830,703 issued Nov. 10, 2020 to Ultima Genomics, Inc. describes a rotational system including a rotating substrate, a detector, and a lens (e.g. a cylindrical lens) between the substrate and the detector. The lens and substrate are tilted relative to one another to produce an anamorphic magnification along a single axis. The anamorphic magnification due to the relative tilt between the lens and the substrate helps to address the image blurring issue, but the imaging resolution of this approach is limited and systems using this approach are unlikely to be able to achieve diffraction limited imaging of the substrate. As such, it is unlikely that high levels of analyte density can be achieved with these systems.

There remains much room for improvement of optical analysis systems and methods using non-linear scanning.

### SUMMARY

We have developed systems and methods for imaging a rotating substrate that incorporate blur correction optics to induce a distortion, for example a trapezoidal distortion, to match the curved scanned area to the rectilinear layout of an array imaging detector, so that a rotationally moving object is transformed into a linearly moving image at the sensor. In some implementations, the blur correction optics include at least a pair of optical elements positioned on either side of the intermediate imaging plane of the optical system. We have discovered that this approach allows for non-linear scanning of the substrate, enabling the capture of diffraction-limited imagery and enhancing scanning efficiency for higher analyte density substrates.

In one example implementation the system includes an objective that collects radiation associated with discrete analyte binding sites on the substrate. The system also includes an actuator configured to rotate the substrate relative to the objective about a rotational axis that is parallel to an optical axis of the objective, such that actuation of the actuator results in a non-linear scanning of the objective relative to the substrate surface, with the non-linear scanning causing infidelities/inaccuracies. At least a pair of optical elements are positioned on either side of the optical system's intermediate imaging plane to correct the image infidelities/inaccuracies, thereby a rotationally moving object is transformed into a linearly moving image at the sensor.

In one example implementation the system, the optical analysis system includes at least one corrector optical element in the optical path between the second optical element and the detector, where the at least one corrector optical element corrects a residual aberration. The at least one corrector optical element is located at or near the pupil relay plane. The detector may include a plurality of rows of detector pixels in a rectangular array. The first and second optical elements apply a trapezoidal distortion to compensate for the non-linear scanning. The detector is a time delay integration (TDI) sensor. Actuation of the substrate actuator results in a differential angular velocity between analyte binding sites that are relatively further away from a rotational axis of the substrate compared to binding sites that are relatively closer to the rotational axis, where the differential angular velocity is associated with the anisotropic distortion.

The optical analysis can distinguish discrete radiation events at the analyte binding sites with the analyte binding sites arranged in an array with an analyte binding site center to center spacing of 1.2 μm or less, 1 μm or less, or 0.8 μm or less, in different configurations.

The first optical element may include at least one optical element selected from the group may include of an x²y plate, an x² plate, a cylindrical lens, and a cone and a cylinder. The second optical element may include at least one optical element selected from the group may include of an x²y plate, an x² plate, a cylindrical lens, and a cone and a cylinder. The first optical element may include at least one optical element which is freeform with an optical phase function that is a two dimensional polynomial function of x and y. The first optical element is implemented as a freeform optical element, combinations of freeform optical elements, combinations of spherical lenses, cylindrical lenses and prisms, diffractive optical elements, and/or metasurfaces.

The second optical element may include at least one optical element selected from the group may include of an x²y plate, an x² plate, a cylindrical lens, and a cone and a cylinder. The second optical element is implemented as a freeform optical element, combinations of freeform optical elements, combinations of spherical lenses, cylindrical lenses and prisms, diffractive optical elements, and/or metasurfaces.

The optical analysis system may include an optical element actuator for adjusting at least one of a position and an orientation of at least one of the first optical element and the second optical element. The substrate actuator is configured to rotate and translate the substrate relative to the objective, where actuation of the substrate actuator results in a spiral scanning of the objective relative to the substrate surface. The optical element actuator adjusts at least one of the position and the orientation of at least one of the first optical element and the second optical element during the spiral scanning of the objective relative to the substrate surface.

The optical analysis system may include a corrector optical element actuator for adjusting at least one of a position and an orientation of the at least one corrector optical element, wherein: (a) the optical element actuator adjusts at least one of the position and the orientation of at least one of the first optical element and the second optical element during the spiral scanning of the objective relative to the substrate surface, and (b) the corrector optical element actuator adjust at least one of the position and the orientation of the at least one corrector optical element during the spiral scanning of the objective relative to the substrate surface. The at least one surface of the substrate is an interior surface of a flow cell.

Implementations of the described techniques may include hardware, a method or process, or computer software on a computer-accessible medium.

### BRIEF DESCRIPTION

The patent or application file contains at least on drawing executed in color. Copies of this patent or patent application publication with color drawing(s) will be provided by the office upon request and payment of necessary fee.

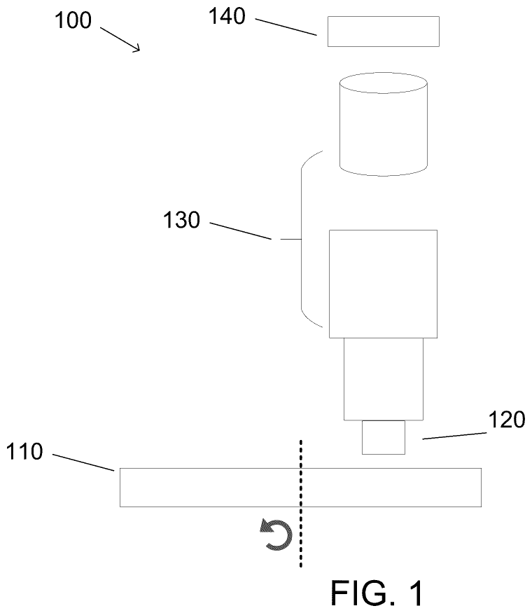

FIG. 1 schematically illustrates an example of a system for nucleic acid sequencing.

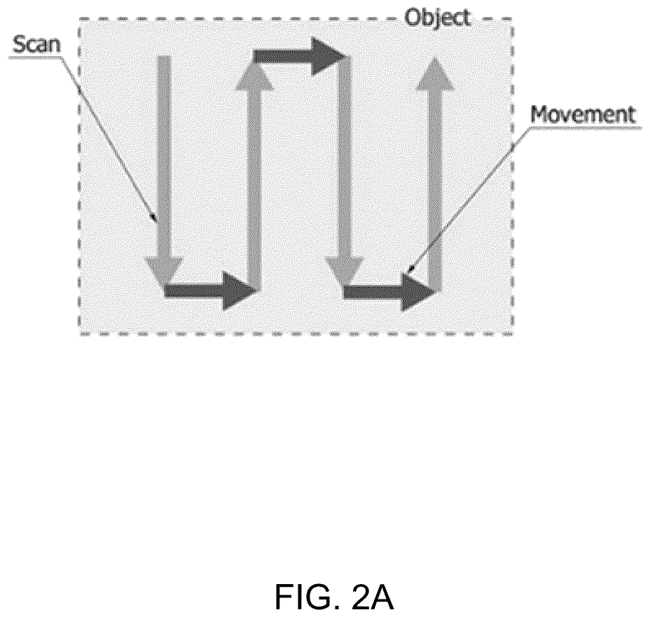

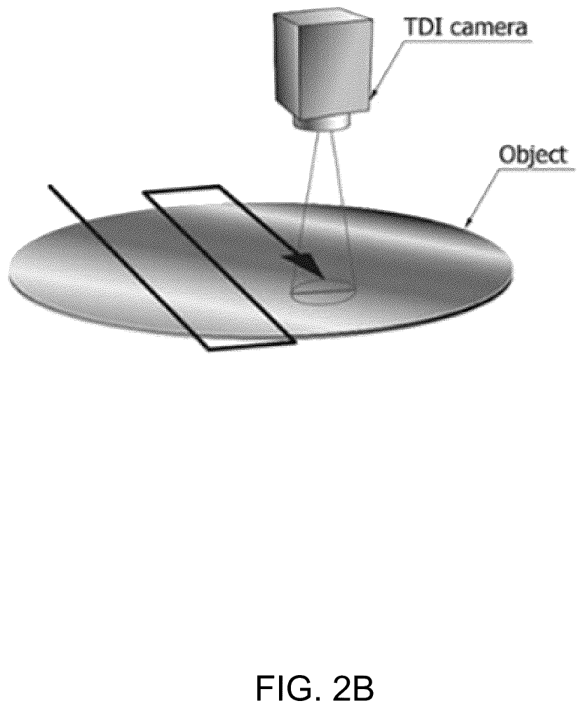

FIG. 2A illustrates an example of bidirectional linear scanning.

FIG. 2B illustrates an example of bidirectional linear scanning with a TDI camera.

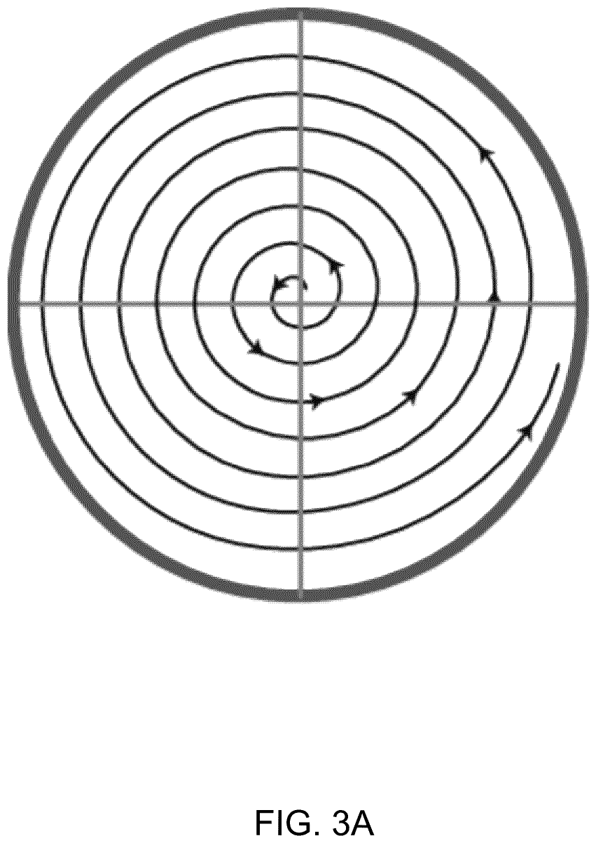

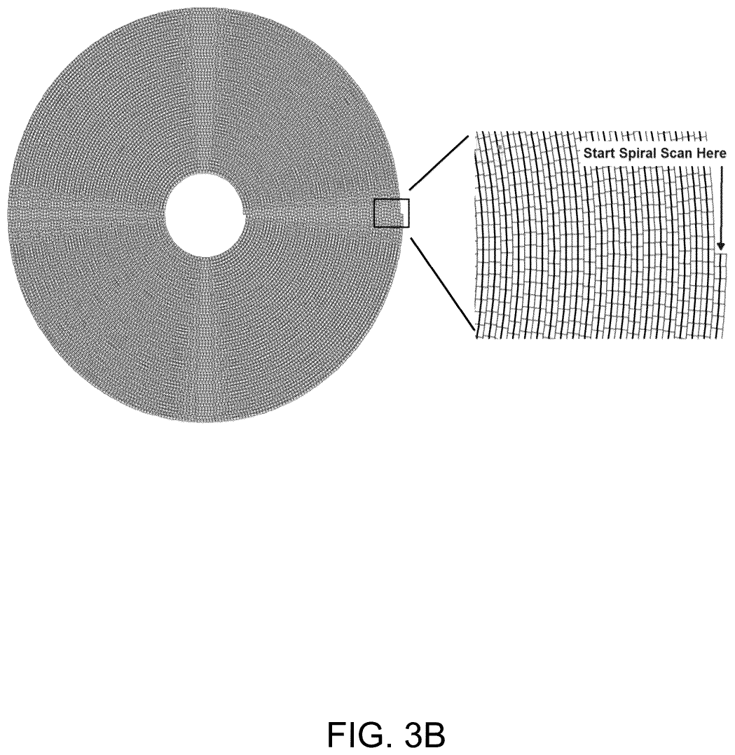

FIGS. 3A and 3B illustrates examples of non-linear scanning.

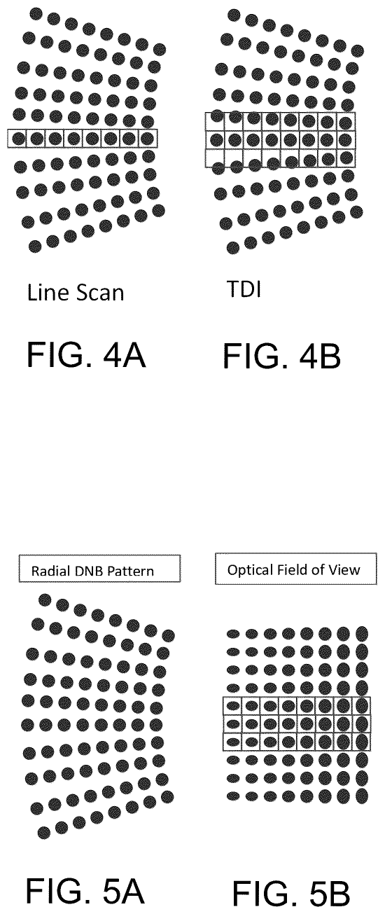

FIGS. 4A and 4B schematically illustrate examples of line scan and TDI scan.

FIGS. 5A and 5B schematically illustrate examples of the radial scanning pattern and the optical field of view.

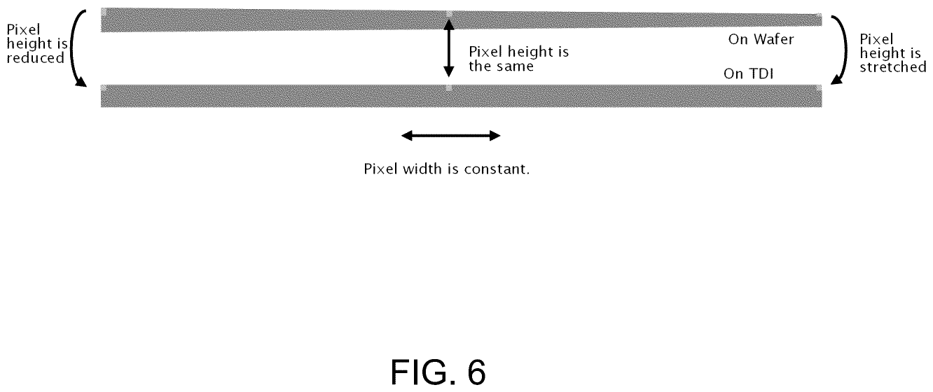

FIG. 6 schematically illustrates examples of distortion of effective TDI pixels.

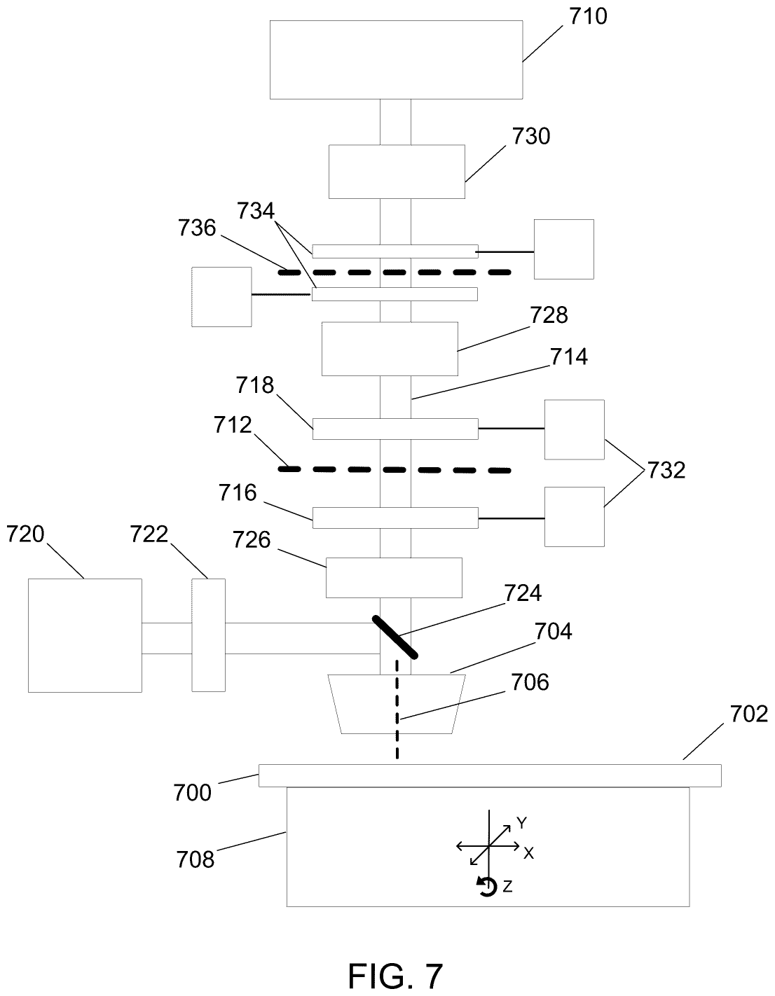

FIG. 7 schematically illustrates an example of a nucleic acid sequencing system.

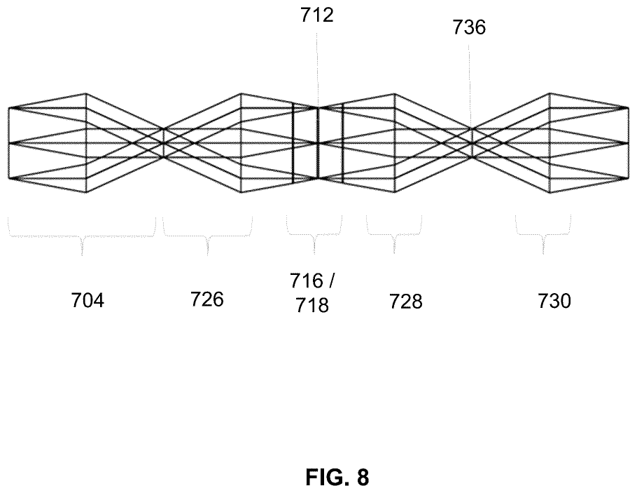

FIG. 8 schematically illustrates some of the optical components of the system of FIG. 7.

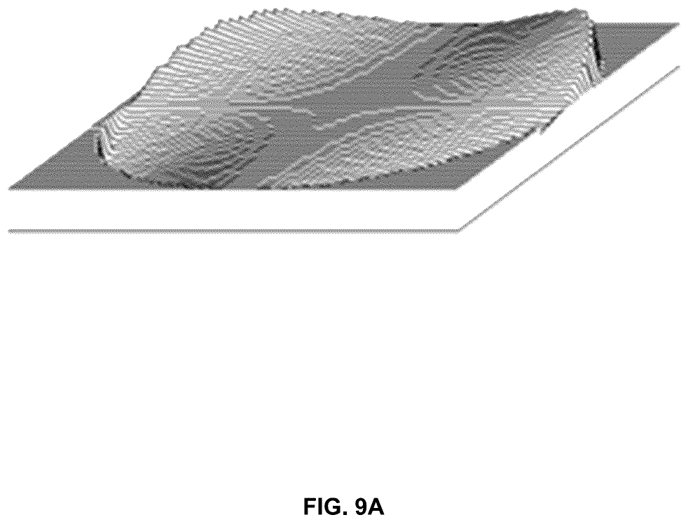

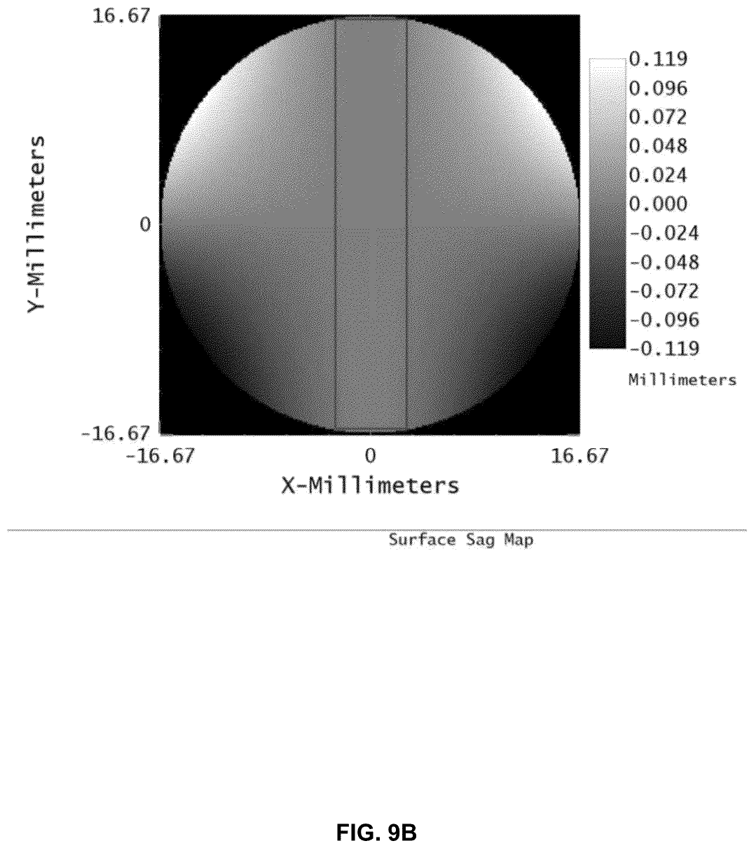

FIGS. 9A and 9B schematically illustrate an example of an X²Y plate.

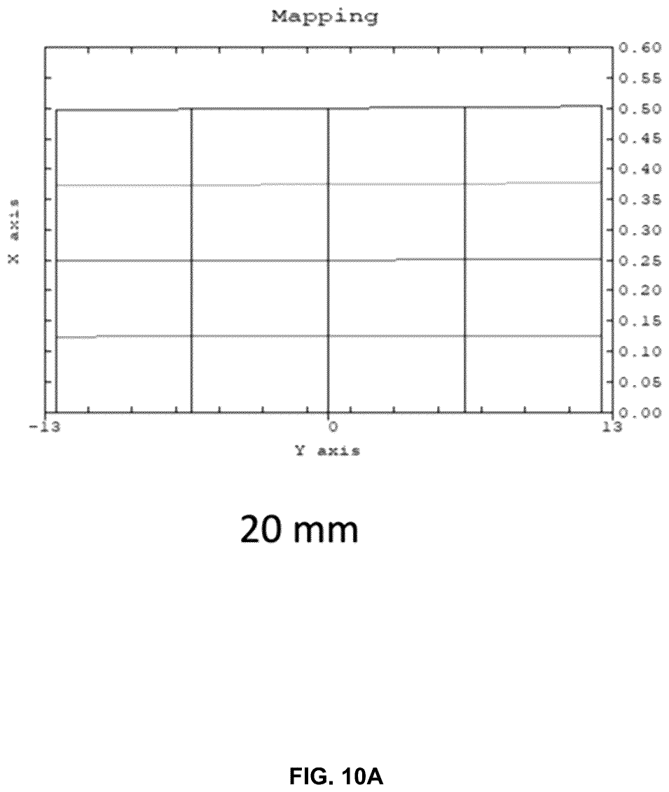

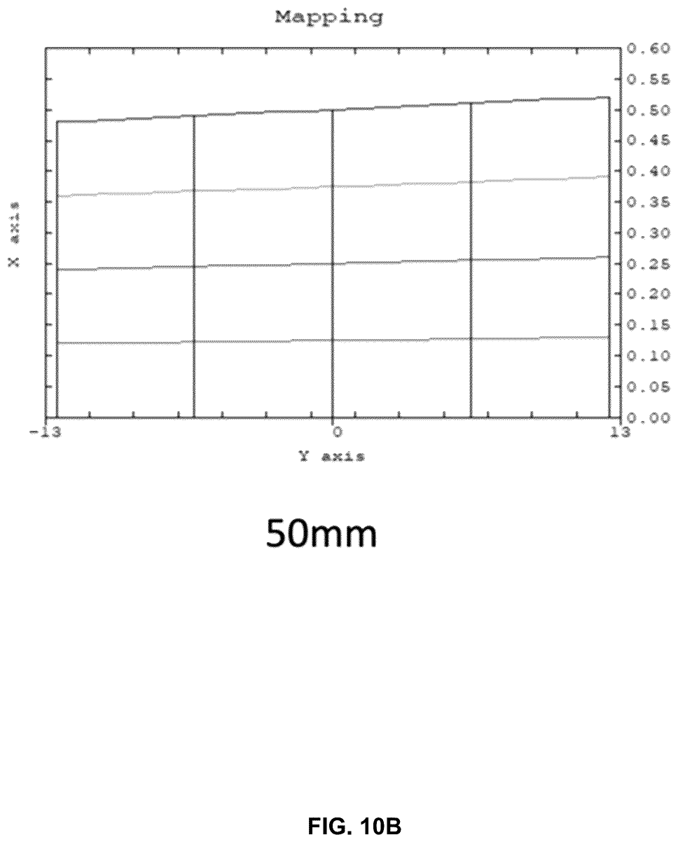

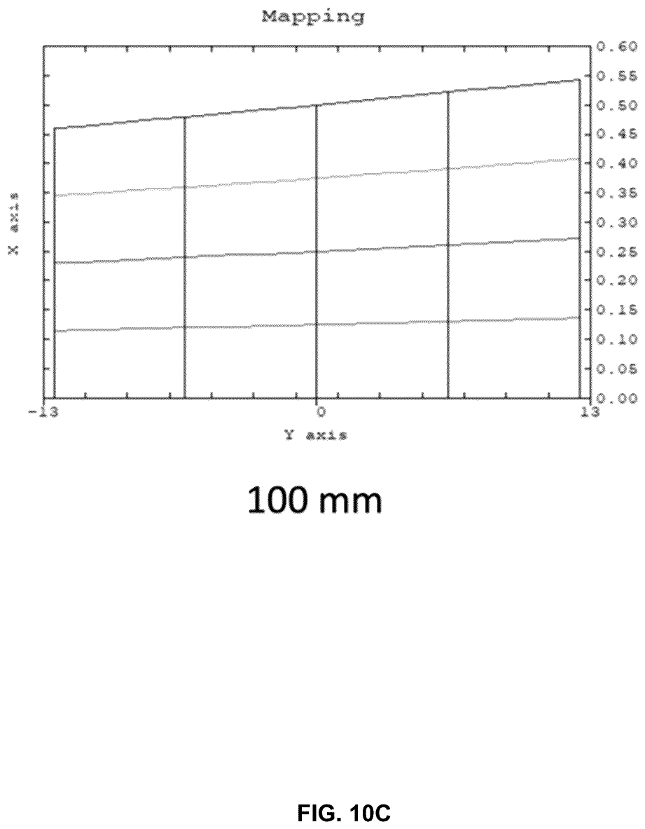

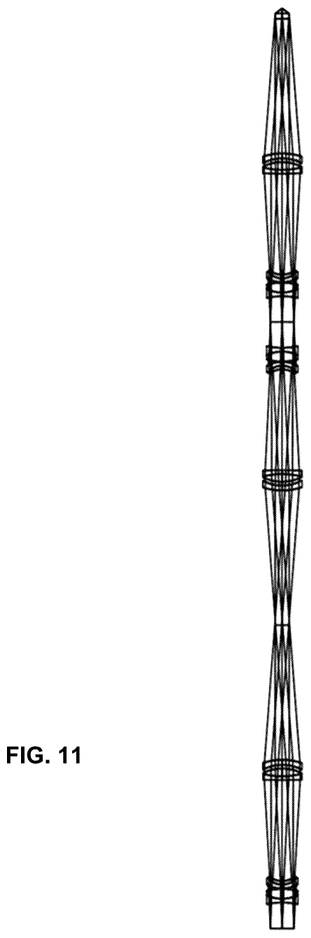

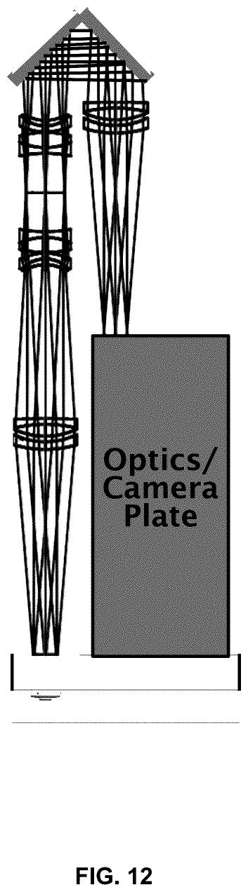

FIGS. 10A-10C illustrates magnification results by varying the distance between a pair of plates.

FIG. 11 schematically illustrates an example of an optical assembly used in a system of nucleic acid sequencing.

FIG. 12 schematically illustrates an example of an optical system used in a system of nucleic acid sequencing.

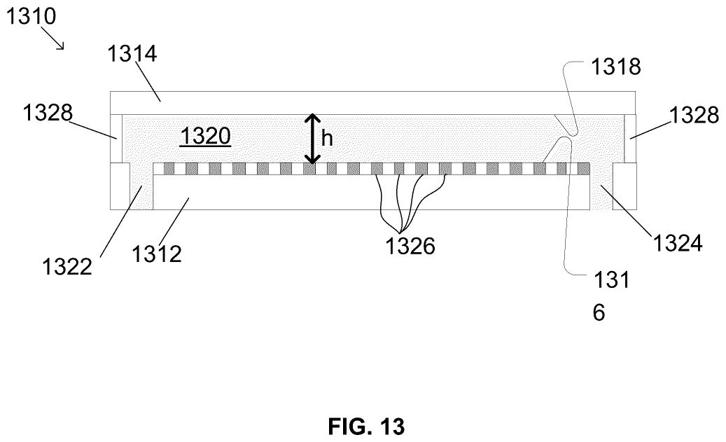

FIG. 13 schematically illustrates an example of a flow cell.

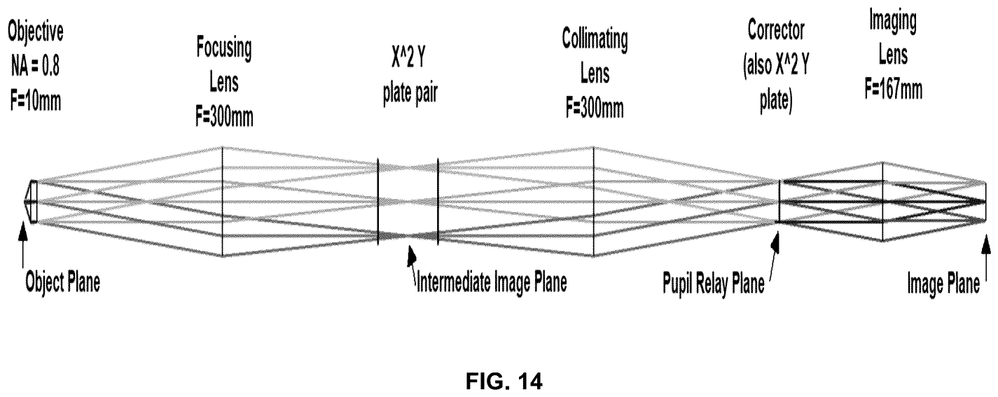

FIG. 14 schematically illustrates an example of X²Y plates system.

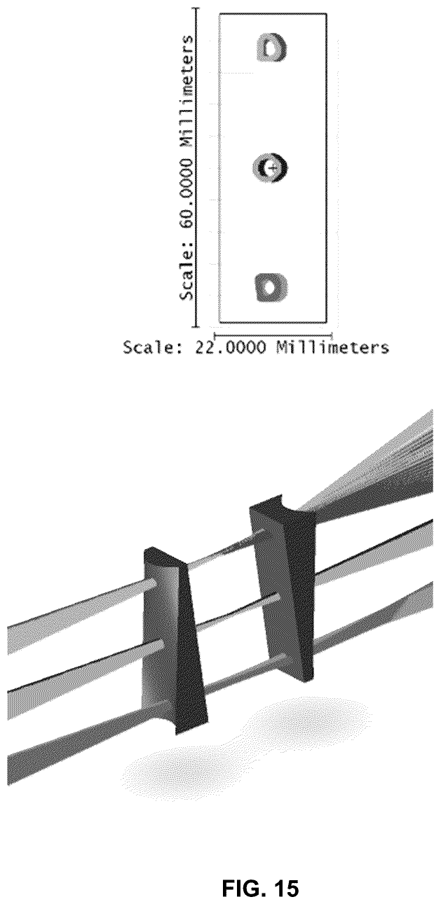

FIG. 15 schematically illustrates an example of a pair of X²Y plates.

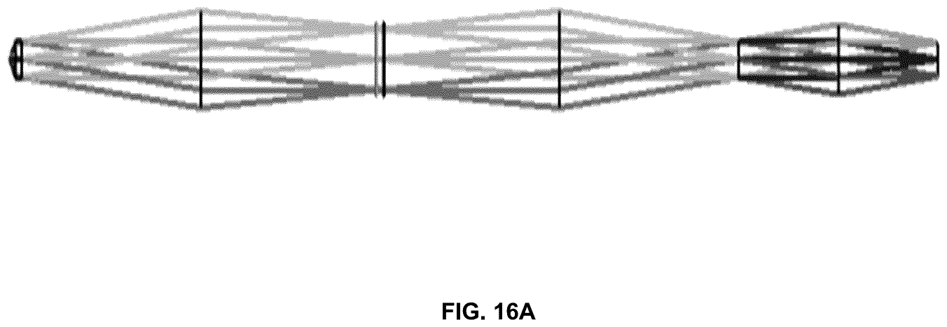

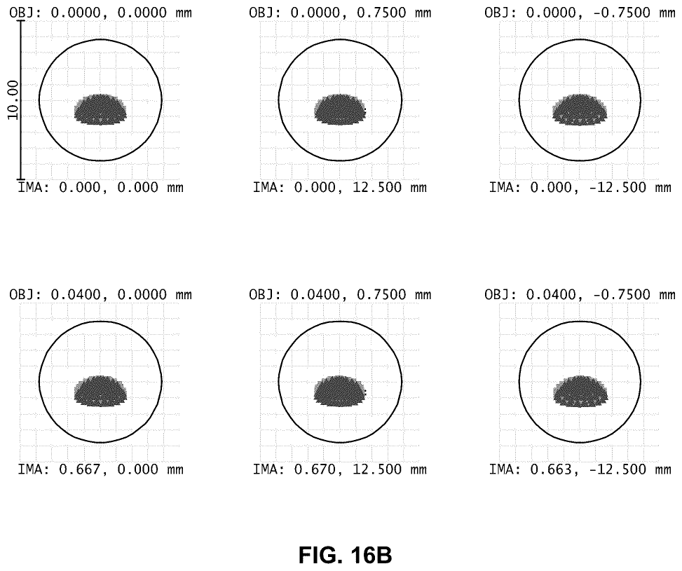

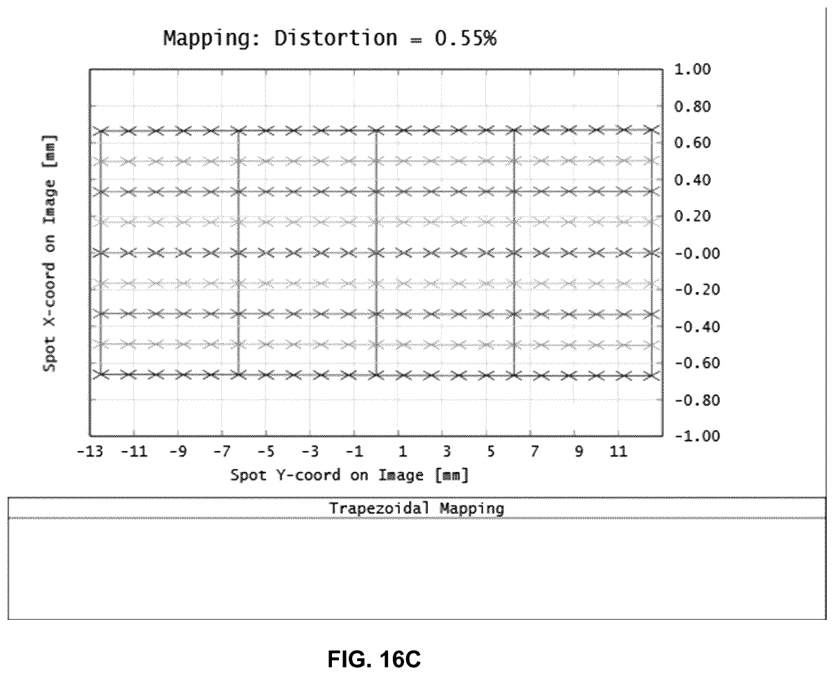

FIGS. 16A-16C schematically illustrates an example of X²Y plates system and its performance when configured for low trapezoidal distortion.

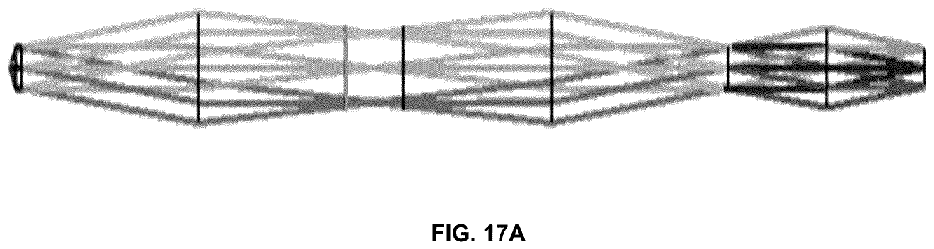

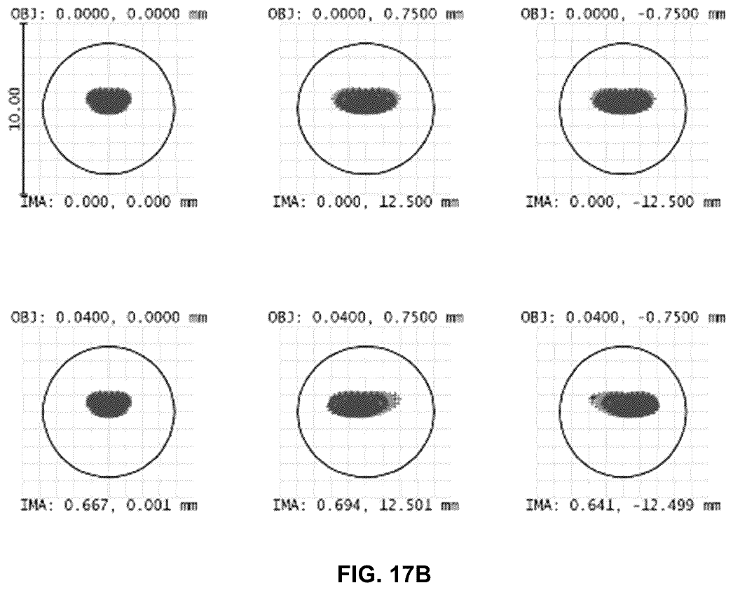

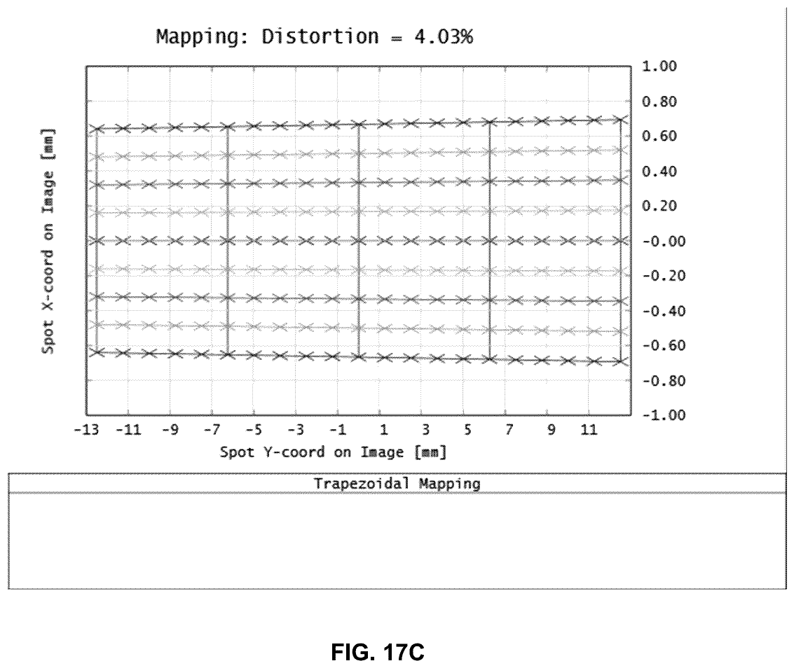

FIGS. 17A-17C schematically illustrates an example of X²Y plates system and its performance when configured for high trapezoidal distortion.

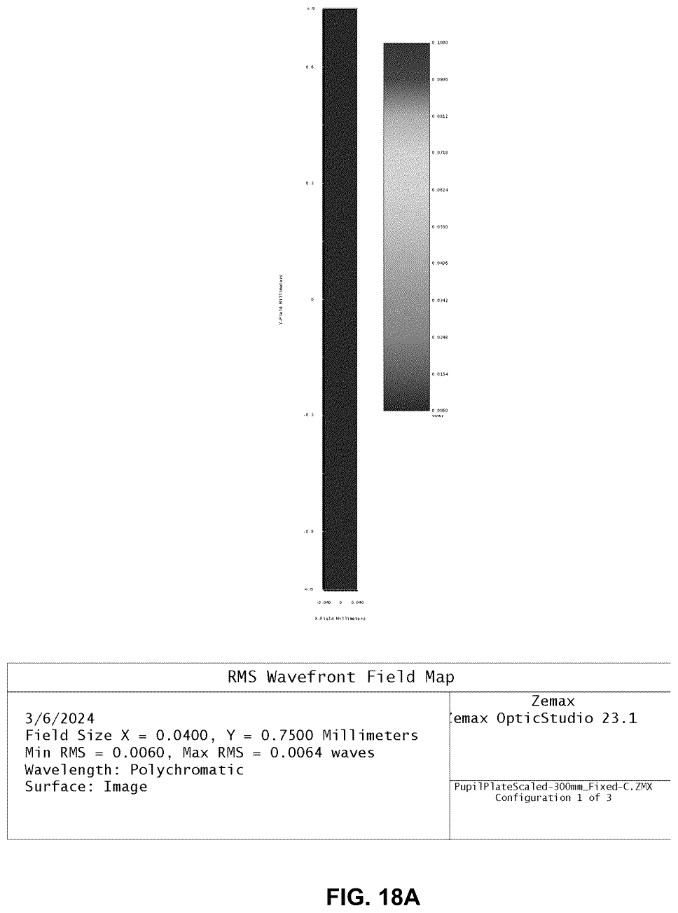

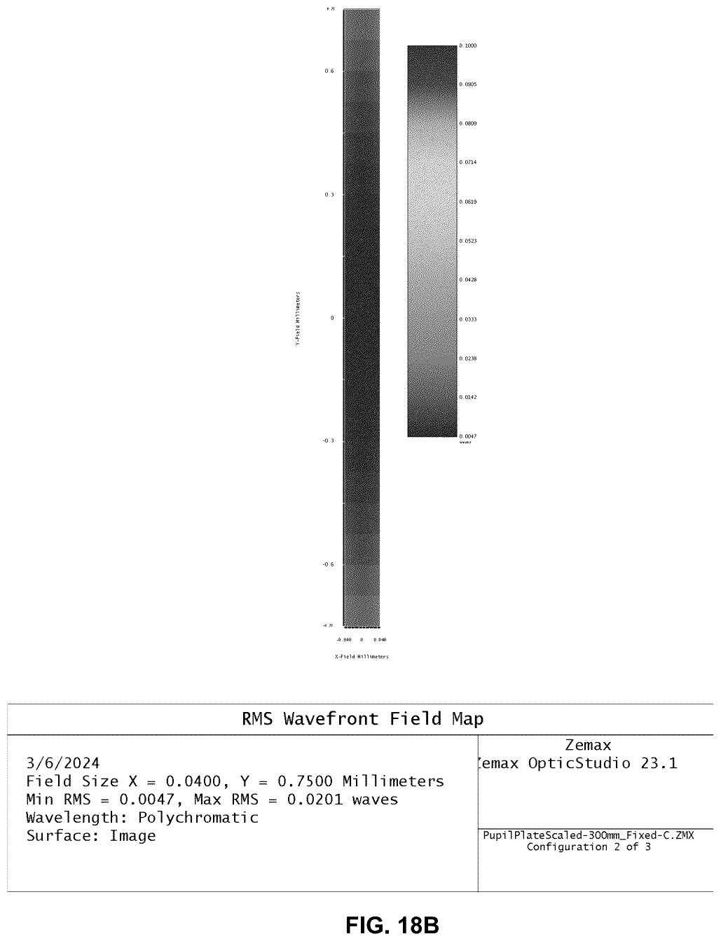

FIGS. 18A-18B schematically illustrates the polychromatic RMS wavefront error maps for low and high distortion configurations.

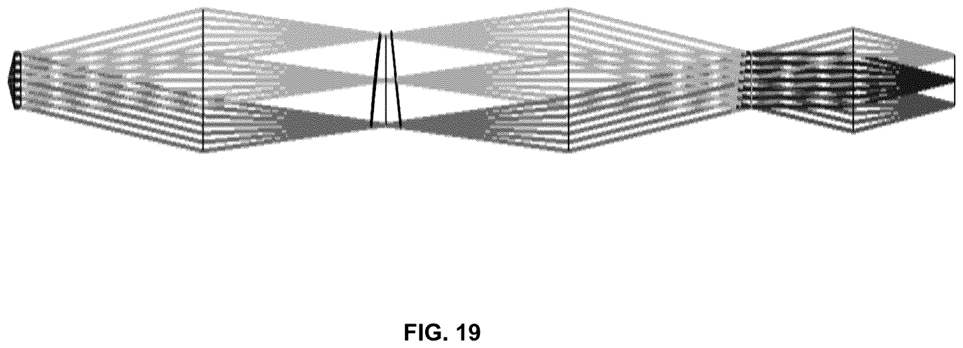

FIG. 19 schematically illustrates an example of a titled cylindrical lenses system.

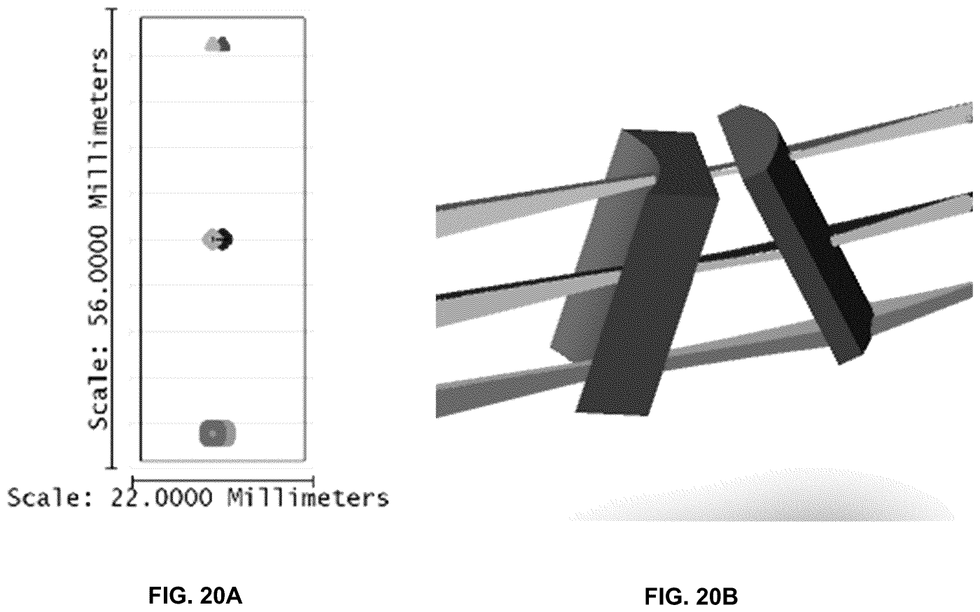

FIGS. 20A-20B schematically illustrates an example of a pair of titled cylindrical lenses.

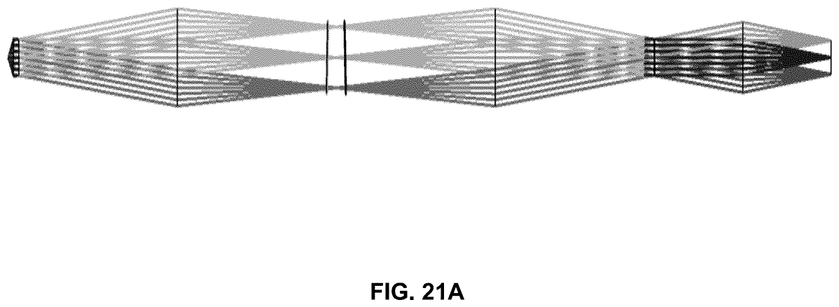

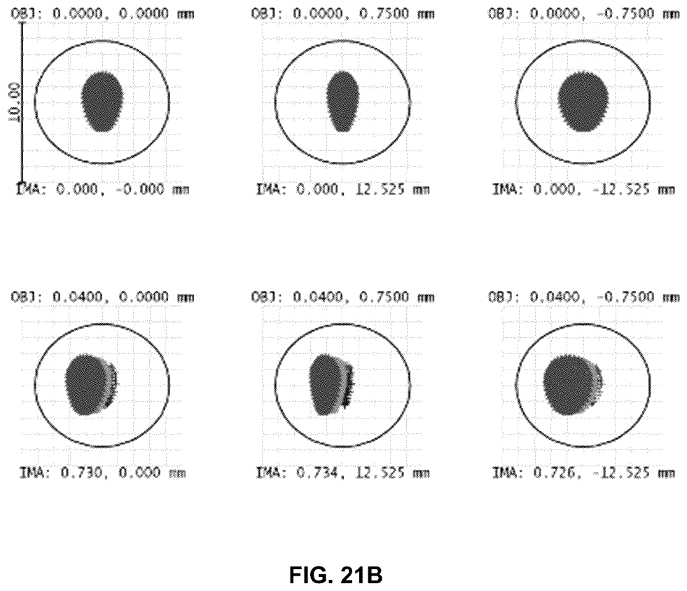

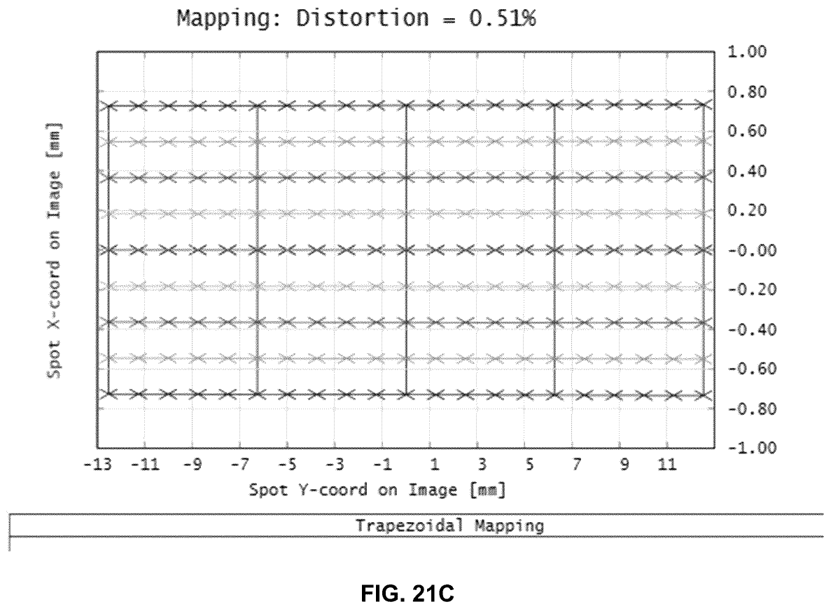

FIGS. 21A-21C schematically illustrates an example of titled cylindrical lenses system and its performance when configured for low trapezoidal distortion.

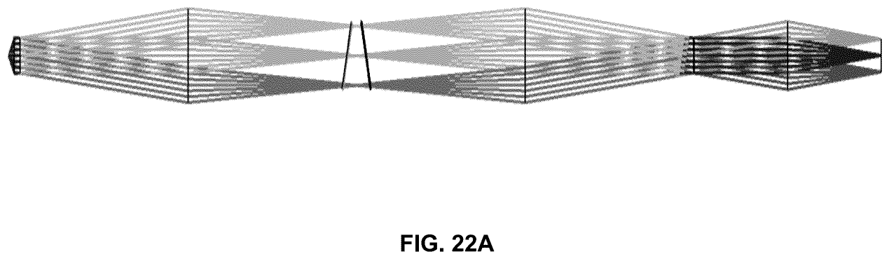

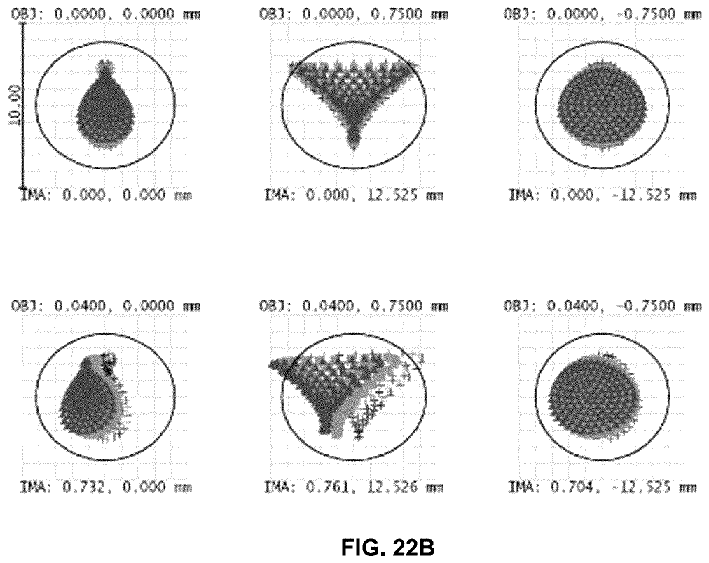

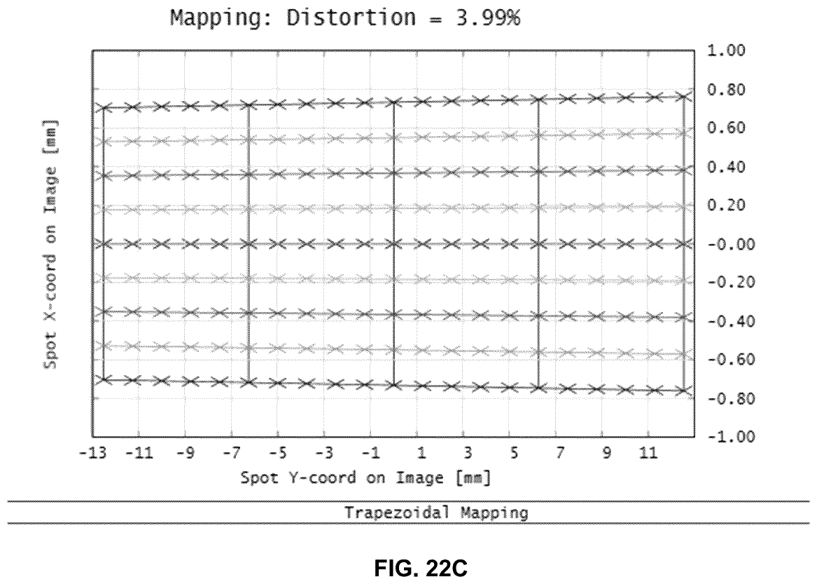

FIGS. 22A-22C schematically illustrates an example of titled cylindrical lenses system and its performance when configured for high trapezoidal distortion.

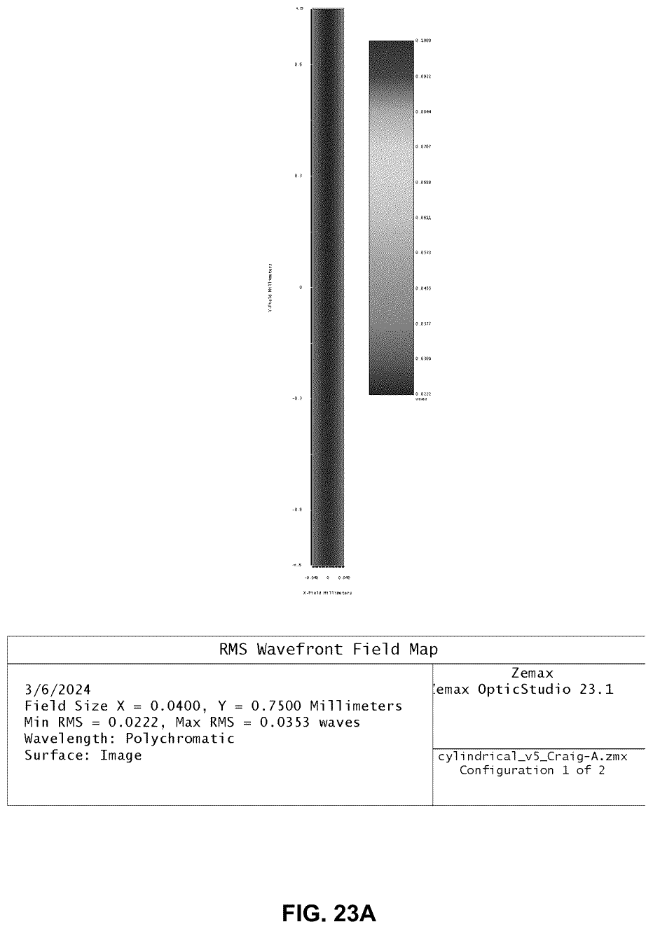

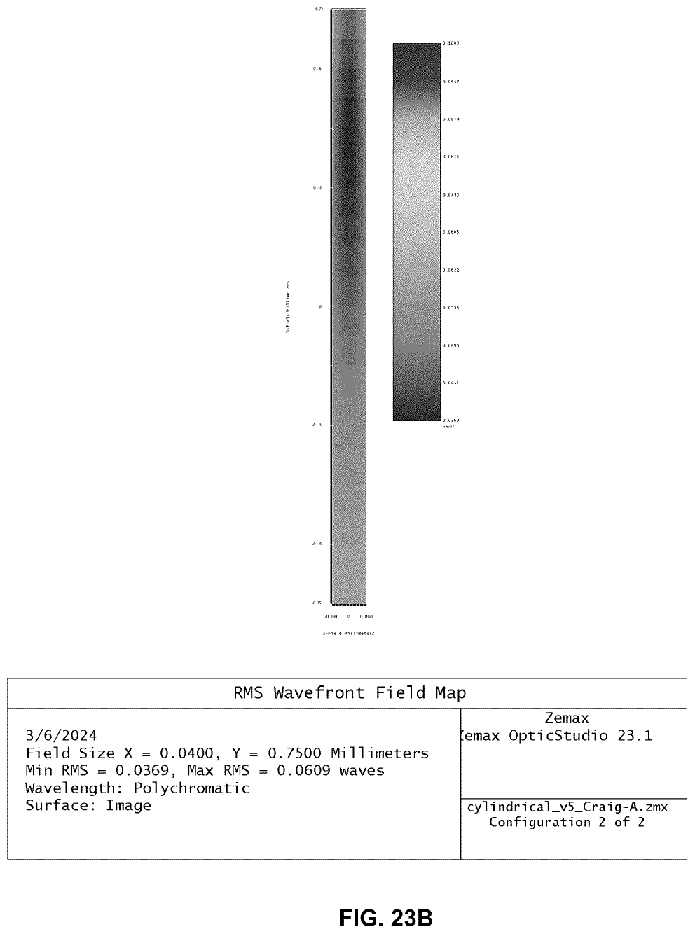

FIGS. 23A-23B schematically illustrates the polychromatic RMS wavefront error maps for low & high distortion configurations.

### DETAILED DESCRIPTION

We describe below examples of methods and systems for correction of imaging infidelities or inaccuracies caused by non-linear scanning. In some implementations the methods and systems may include a substrate, a substrate actuator, an objective, and a detector. The substrate includes at least one surface with an array of discrete analyte binding sites each configured to immobilize an analyte (e.g. a nucleic acid). The objective is configured to collect radiation associated with the discrete analyte binding sites. The substrate actuator is configured to rotate the substrate relative to the objective, which results in a non-linear scanning of the objective relative to the substrate surface.

In this example the method and system include a first optical element (which may be one or more optical elements) positioned in an optical path of the system between the objective and an intermediate image plane of the optical system, and also include a second optical element (which may be one or more optical elements) positioned in the optical path of the system between the intermediate image plane and the detector. The first and second optical elements are configured to create the distortion required by correcting the infidelities or inaccuracies caused by the non-linear scanning. In some implementations, the optical elements are freeform non-cylindrically symmetric optical plates, configured to induce a distortion, for example anisotropic distortion, to match the curved scanned area of the non-linear scanning system to the rectilinear layout of an array imaging detector. In other implementations other optical elements may be used in addition to or instead of the freeform non-cylindrically symmetric optical plates, including for example other freeform optical elements, a cylindrical lens, a cone and a cylinder, combinations of freeform optical elements, combinations of spherical lenses, cylindrical lenses and prisms, diffractive optical elements, and/or metasurfaces.

### Nucleic Acid Sequence Detection

The systems and methods described herein may be used for detecting sequencing events on a rotating substrate, such as for sequencing template nucleic acid molecules that are bound to or otherwise disposed in an array on the surface of the substrate.

There are many approaches to nucleic acid (e.g., DNA) sequencing. See, e.g., Kumar, K., 2019, “Next-Generation Sequencing and Emerging Technologies,” Semin Thromb Hemost 45(07): 661-673. The most popular methods use arrays with a large number of discrete sites (e.g., 100 million to 1 billion or more) in an ordered array on a planar substrate. Typically, the sites are small (e.g., characterized by a diameter or diagonal less than 1 micrometer, often less than 500 nanometers, and often in the range of 50 nanometers to 500 nanometers) and desirably present at a high density (e.g., of more than about 106 sites per cm²). Nucleic acid templates are immobilized directly or indirectly at the individual sites for sequencing. Generally, each site may contain a clonal population of template sequences, such as a DNA nanoball (DNB, Complete Genomics, Inc.) or PCR products or amplicons (Illumina, Inc.).

For illustration and not limitation, in these approaches nucleic acid sequences are determined one base at a time over a series of sequencing “cycles.” Each cycle comprises (i) introducing reagents to each site on the array of immobilized template molecules; (ii) carrying out a series of biochemical or enzymatic reactions (“sequencing reactions”) simultaneously at the sites; (iii) detecting signals at each site (zero, one, or more than one signal per site per cycle) which may be referred to as “image acquisition”; and (iv) carrying out enzymatic, washing, or regeneration steps at each site on the array so that another sequencing cycle can be carried out. Without limitation the “signals” collected in (iii) may be optical signals, e.g., fluorescence or luminescence signals. The sequencing array is usually contained in a “flow cell” or other substate through and/or on which primers, reagents, washes, etc. can be flowed. Typically, a sequencing run consists of approximately 400 cycles, which means that approximately 400 or more imaging events (i.e. an optical scan of the entire substrate surface), each involving acquiring signal individually from each of millions of sites is required. The speed and precision of image collection affects cost, efficiency, and sequencing data quality.

As used herein a “sequencing event” refers to emission of an optical signal (e.g., a fluorescence or luminescence signal) resulting from a sequencing process. An exemplary sequencing process is a cycle of a sequencing-by-synthesis process. In this approach, nucleotides are incorporated into a primer extension product (e.g. using reversible terminator nucleotides). In this approach, nucleotides can be labeled with, for example, a fluorescent dye or a source of a luminescence signal (e.g. luciferase or luciferase substrate). A luminescent signal includes chemiluminescence and bioluminescence. A nucleotide can be labeled directly with a fluorescent dye or a source of a luminescence signal or can be associated with an antibody, aptamer or other agent labeled with a signal generating moiety. In the process of sequencing a defined optical signal is produced at each site in an array by, for example, illumination of the fluorescent dye(s) with an excitation wavelength, and the signals and corresponding positions are recorded.

Although framed in the context of nucleic acid sequencing, it will be recognized that the systems and methods disclosed herein are not limited to nucleic acid sequencing uses. The system may be used, for example, for nucleic acid analysis other than sequencing (e.g., SNP analysis, real time PCR analysis) or for analysis of chemical or biochemical processes using substrates or analytes other than nucleic acids.

FIG. 1 schematically illustrates an example of a nucleic acid sequencing system. In the embodiment depicted in FIG. 1, the nucleic acid sequencing system 100 includes a substrate 110, an objective 120, an optical assembly 130, and a detector 140. The objective 120 collects radiation from the substrate 110. The optical assembly 130 receives the radiations from the objective 120 and focuses them onto the detector 140. In this particular example the objective 120 collects fluorescent light related to sequencing events on the substrate 110, and the optical assembly 130 then directs this light to the detector 140.

The detector 140 may be a sensitive camera or photomultiplier tube that can accurately record the different fluorescent signals. These signals are then converted into digital data, which can be analyzed by a computer to determine the sequence of the DNA. The detector 140 may be a Charge-Coupled Device (CCD), a Complementary Metal-Oxide-Semiconductor (CMOS) in a digital camera, or a photomultiplier tube (PMT). The choice of detector 140 can affect the sensitivity and speed of the detection system.

In this example, the detector 140 is a Time Delay Integration (TDI) sensor having several rows of detector pixels arranged in a rectangular array.

### Non-Linear Scanning

The systems and methods described herein utilize non-linear scanning as opposed to linear scanning. Linear scanning refers to a methodical, row-by-row or column-by-column traversal across the surface of the substrate, systematically capturing data in a predetermined sequence along straight scanning pathways. Linear scanning encompasses the relative motion between the objective and the substrate that is characterized by a trajectory composed of straight lines. For instance, an objective relatively traverses over a substrate following a linear path (e.g. either by translating the substrate along a linear path relative to a stationary objective or by translating an objective or other optical component of the system relative to a stationary substrate) while imaging the substrate. In the context of capturing an image from a two-dimensional substrate via linear scanning, the relative translation may occur along the x-axis and/or the y-axis, as exemplified in FIGS. 2A and 2B.

In linear scanning, there is downtime when the scan stops moving in one direction, translates to the next line, and then accelerates to scan the next line. The systems and methods described herein employ non-linear scanning, which, in at least some implementations, can include continuous movement during imaging of the entire substrate, eliminating this downtime associated with linear scanning.

Non-linear scanning refers to scanning methods where the relative movement of the objective to the substrate does not follow a linear path. Instead, these methods involve more complex trajectories, such as curves. Non-linear scanning offers a more dynamic approach. Non-linear scanning includes but is not limited to rotary scanning and spiral/helical scanning. This technique involves scanning in a non-linear pattern across the sample, allowing for efficient and systematic data collection. FIGS. 3A and 3B show examples of helical/spiral non-linear scanning paths. In addition to eliminating the downtime associated with linear scanning, in the context of nucleic acid sequencing, these non-linear methods may provide additional advantages such as reduced photobleaching in fluorescence microscopy and higher resolution imaging. Non-linear scanning may enhance the efficiency and accuracy of data collection and analysis in various biological and biomedical applications.

Non-linear scanning may be used with, for example, either a line scan detector or a Time Delay Integration (TDI) detector. A line scan camera typically has a single row of pixels and captures images one line at a time. FIG. 4A schematically illustrates an example of a field of view of a line scan camera (with the pixels of the line scan camera indicated by the square boxes) being scanned over a rotating substrate, only a portion of which is shown in FIG. 4A, with the analyte sites on the substrate indicated by the radially arranged rows of circles. The line scans may be compiled by the system to form a complete image.

In contrast, TDI cameras have multiple rows of pixels, for example, a configuration with 3 rows of pixels in a rectangular array as illustrated in FIG. 4B. Each row sequentially captures the same line of the image, one after the other, as the substrate rotates. The image line is exposed to several rows of pixels as it moves, with the charge being transferred from one row to the next, synchronously with the motion of the object. This effectively adds the signal from each exposure together, with the integration process significantly increasing the camera's sensitivity to light and its ability to capture images in lower light conditions or at higher speeds. In some implementations the accumulation of signal from multiple exposures (from each row of pixels) to the same line of the image reduces noise and improves the dynamic range.

TDI sensors may include but are not limited to TDI CCD (Charge Coupled Device) sensors and TDI CMOS (Complementary Metal-Oxide-Semiconductor) sensors. TDI sensors use the TDI technique to improve the signal-to-noise ratio by summing the signal from multiple exposures of the same field of view as the sensor and/or the substate moves. It works by synchronized mechanical and electronic scanning so that the effects of dim imaging targets on the sensor can be integrated over longer periods of time. TDI sensors accumulate light over a series of stages, each corresponding to a row of pixels in the sensor, and synchronize the movement of the sensor's pixel rows with the motion of the object being imaged. By accumulating signal across multiple stages, TDI sensors can significantly reduce image noise. This is especially beneficial in situations where the light is limited or fluctuating. To get good TDI image quality, the shifting of accumulated charge in the sensor must match the motion of the image across the sensor; if there is not a good match the accumulated image will be smeared and blurry.

Non-linear scanning, when employing a TDI sensor, may present more complexity compared to linear scanning due to the increased challenge of synchronizing with the linear charge transfer process used in the TDI sensor. For example, in implementations in which the substrate rotates about an axis of rotation, portions of the substrate further away from the center of rotation will have greater linear velocities in comparison to portions of the substrate that are closer to the center of rotation. As such, portions of the substate that are further away from the center of rotation (and the analyte sites associated with those portions) may in some implementations move faster through the sensors' field of view compared to portions of the substrate that are closer to the center or rotation (and the analyte sites associated with those portions). This difference in velocity can disrupt the synchronization required for effective TDI sensor operation, potentially leading to motion blur. As illustrated in FIG. 4B, the differing velocities experienced during non-linear scanning cause the analyte sites to shift position relative to the additional rows of pixels in a TDI setup. This positional shift is perceived as a smear and/or blur in the captured image.

### Blur Mitigation

In some implementations of the non-linear optical analysis systems and methods described herein, optical blur compensation may be used to remove the linear velocity gradient across the image. For example, specialized optics can create a linear variation in vertical magnification across the Field of View (FOV) to correct the blur. The effect of this correction is that the pixel size on the sample will be approximately rectangular and the height will vary across the FOV. When the images are displayed with square pixels, the dimensions at the inner radius will be stretched vertically, while those at the outer radius will be compressed, as illustrated in FIG. 5B. FIG. 5A shows round analytes laid out on a portion of a substrate; FIG. 5B shows distorted shapes as seen across the FOV. This occurs without data loss in the process. The image is matched to the rectangular pixel array of the TDI, and the blur is corrected.

In one example implementation, the TDI (Time Delay and Integration) sensor has square-shaped pixels, each having dimensions of P micrometers by P micrometers (height×width), where P represents the length of each side of the pixel. The sensor has an array of N×M pixels, for example 3×8 pixels as depicted in FIG. 5B. During the process of non-linear scanning, this TDI sensor executes a non-linear scanning motion over the substrate. This scanning is performed in a manner where each square spot, as illustrated in FIGS. 3A and B, is sequentially scanned one after another following a non-linear trajectory.

In systems with optical magnification, the effective size of the pixel in the final image is changed. For example, if the imaging system has optical magnification, a 2× vertical magnification would effectively double the height of each pixel in the captured image, making it 2P in height while maintaining the original width. In systems without optical blur compensation, the vertical magnification would be uniform across the width of the field of view.

In certain implementations of systems with optical blur compensation, the effective magnified height of many of the pixels will vary across the field of view. For example, in the example of FIG. 6, the effective width of the pixels remains constant across the field of view while the effective height of the pixels varies across the field of view. The effective pixel height in the middle of the spot is the same, while the pixel height of the spot at the inner radius will be stretched vertically, while those at the outer radius will be compressed. In some implementations, the degree of differential magnification across the width of the field of view may remain constant throughout the non-linear scanning process. In other implementations, the degree of differential magnification across the width of the field of view may vary as the non-linear scanning moves closer to or further away from the center of rotation. For example, the differential magnification when scanning closer to the center of rotation may be greater (due to greater differences in linear velocities across the width of the field of view) than the differential magnification when scanning further away from the center of rotation (due to less differences in linear velocities across the width of the field of view). Table I shows one example of how relative magnification can vary at different scan radii from the center of rotation of the substrate for a 1.5 mm wide scan.

TABLE 1
Magnification requirements at different scan radii

| | |
|---|---|
| 20 mm Radius | 0.9625X to 1.0375X |
| 100 mm Radius | 0.9925X to 1.0075X |

As described in further detail below, relative magnification can be adjusted as the scan radius changes by adjusting the position of two or more optical elements relative to one another, for example by adjusting relative spacing or tilt of those elements.

### Optical Correction Assembly

FIGS. 7 and 8 show an example of a system configured to mitigate the blurring issue discussed above. In this example the system includes a substrate 700 with surface 702, an objective 704 having an optical axis 706, a substrate actuator 708, a detector 710, an intermediate image plane 712 in an optical path 714 between the objective 704 and the detector 710, a first optical element 716, and a second optical element 718.

In this example the surface 702 of the substrate 700 has an array of discrete analyte binding sites each configured to immobilize an analyte. The objective 704 is configured to collect radiation associated with the discrete analyte binding sites of surface 702 while the substrate actuator 708 rotates the substrate 700 relative to the objective 704, resulting in a non-linear scanning of the objective 704 relative to the substrate surface 702.

The radiation emitted from the discrete analyte binding sites may be stimulated by laser light from radiation source 720. For example, in some implementations, radiation source 720 emits laser light that stimulates fluorescent emissions by fluorescently tagged analyte on substrate surface 702. The laser light from the radiation source 720 passes through conditioning optics 722 (e.g., beam delivery and beam shaping optics), directing optics 724, and objective 704 to the substrate 700. Directing optics 724 may be a dichroic beam splitter or other optical component configured to reflect light wavelengths from radiation source 720 while allowing other light wavelengths (including the fluorescent emissions from tagged analyte on substrate surface 702) to pass through the directing optics 724 along the optical path 714 to the detector 710. Although FIG. 7 only shows a single radiation source 720 for stimulating fluorescent emissions by tagged analyte, additional radiation sources operating at different wavelengths may be included, in conjunction with additional conditioning and directing optics for those additional radiation sources.

In this particular example, the substrate actuator 708 is configured to both rotate the substrate 700 about a vertical rotational axis Z and translate the substrate 700 along one or more horizontal axes (e.g. X and/or Y), which results in a spiral or helical scanning of the objective 704 relative to the substrate surface 702. In this particular example, rotation of the substrate 700 by the substrate actuator 708 results in a differential angular velocity between analyte binding sites that are relatively further away from the rotational axis of the substrate 700 compared to binding sites that are relatively closer to the rotational axis.

As discussed above, the non-linear scanning may be associated with an anisotropic distortion (e.g. caused by the differential angular velocity of analyte binding sites within the relevant field of view). In the example of FIG. 7, the first and second optical elements 716 and 718 create the anisotropic distortion. The first optical element 716 is positioned in the optical path 714 between the objective 704 and the intermediate image plane 712 and the second optical element 718 is positioned in the optical path 714 between the intermediate image plane 712 and the detector 710. We have discovered that this approach allows for, among other benefits, diffraction limited imaging of the non-linearly scanned substrate 700, such that higher analyte densities on the substrate surface 702 can be achieved. In certain implementations, the system can distinguish discrete radiation events at the analyte binding sites with the analyte binding sites arranged in an array with an analyte binding site center to center spacing of 1.2 μm or less, of 1 μm or less, or of 0.8 μm or less.

In this example the detector 710 may be a TDI sensor or other sensor including multiple rows of detector pixels in a rectangular array, with the first and second optical elements 716, 718 configured to apply a trapezoidal correction to achieve a high-fidelity image from the TDI sensor. In other implementations, the first and second optical elements 716, 718 may be configured to introduce other distortions, including other types of anisotropic distortions or other distortions, to match a curved scanned area to the rectilinear layout of the array imaging detector, so that a rotationally moving object is transformed into a linearly moving image at the TDI sensor.

As shown in FIGS. 7 and 8, the optical components of the system may include objective lens 704, focusing lens 726, first optical element 716, second optical element 718, collimator 728, and imager 730. First and second optical elements 716, 718 may be disposed between the focusing lens 726 and collimator 728 on opposite sides of the intermediate image plane 712. Imager 730 may be an imaging lens.

In some implementations the first and second optical elements 716, 718 are part of an optical phase assembly with at least two optical plates configured to compensate for the non-linearly scanning. In some embodiments, the optical phase assembly provides the trapezoidal distortion so that a rotationally moving object is transformed into a linearly moving image at the sensor.

In some implementations, the first and second optical elements 716, 718 are part of an optical phase assembly with at least two non-cylindrically symmetric optical plates configured to correct the infidelity of detector 710 resulting from the non-linearly scanning, to match the curved scanned area to the rectilinear pixel array of detector 710.

In some embodiments, the at least two non-cylindrically symmetric optical plates are an optical phase assembly of two or more optical phase plates, and a phase value of one of the two or more non-cylindrically symmetric optical plates is a function of x²y, with x and y representing the horizontal and vertical axes, respectively, in a horizontal plane perpendicular to the optical axis of the system. In some embodiments, the phase value of the optical phase plate may be given by:

$$h = {t}_{0} + {t}_{c} {x}^{2} y$$

where t₀ is the axial thickness of the non-cylindrically symmetric optical plate and t_{c} relates the power of the non-cylindrically symmetric optical plate (units of t_{c} are 1/mm², assuming h, t₀, x, and y all have units of mm). FIGS. 9A and 9B illustrate one example of a profile of the phase value. In some embodiments, the phase value for each of the two or more phase plates is a function of x²y. In some embodiments, the phase value for each of the two or more phase plates is given by the equation of h=t₀+t_{c}x²y as previously discussed

In some implementations, the thickness of the plate to ranges from less than 1 mm to several millimeters. The phase profile value can vary from 1 micrometer 100 micrometers.

In some implementations, the at least two non-cylindrically symmetric optical plates are an optical phase assembly of two or more optical phase plates, and a phase value of one of the optical phase plates is, h=t₀+t_{c}x² where t_{c} has units of 1/mm if h, t₀, and x all have units of mm.

In some implementations, the at least two non-cylindrically symmetric optical plates may be replaced with two optical plates, each possessing a cylindrical surface. The cylindrical surface can be expressed as:

$$h = {t}_{0} + \frac{{x}^{2} / R}{1 + \sqrt{1 - {( \frac{x}{R} )}^{2}}} ,$$

wherein h is the phase height, R is cylindrical surface can be expressed as: the radius of the curvature of the lens, and x is the distance from the optical axis in a plane perpendicular to the optical axis. In certain configuration, the at least two optical plates may be two true cylindrical lenses.

In some implementations, the phase plates are positioned near an intermediate focus. In cases where the image is rectangular, only the area encompassed within the central rectangle region is utilized. Moreover, the design of the phase plate can be adapted, with the utilized portion varying in shape and size depending on the specific application.

In some implementations, the non-cylindrically symmetric optical plates are a pair of optical plates that are configured to provide a trapezoidal distortion to match the curved scanned area of a non-linear scanning system to the rectilinear layout of an array imaging detector, so that a rotationally moving object is transformed into a linearly moving image at the sensor. As illustrated in FIG. 8, a separation is formed between the plates 716, 718, and the length of the separation along the optical axis may be varied to adjust the differential magnification. For instance, as shown in FIG. 7, each of the optical elements 716, 718 may be associated with an optical element actuator 732 for adjusting relative positions of the optical elements 716, 718. In other implementations (including implementations using other types of optical elements such as cylindrical lenses), actuators 732 may be configured to adjust relative tilt of the optical elements 716, 718, or to adjust both tilt and position of the optical elements 716, 718 relative to each other. In some implementations, actuators 732 may be used to adjust at least one of the position and the orientation of at least one of the optical elements 716, 718 during spiral scanning of the objective 704 relative to the substrate surface 702.

As noted above, some implementations utilize a pair of non-cylindrically symmetric optical plates, for example, a pair of plates with a phase function of x²y or a phase function of x² that is placed between the objective 704 and the collimator 728 to adjust the distortion. FIGS. 10A-10C show the performance of the example embodiment as the separation between the pair of plates are varied from 20 mm, to 50 mm and 100 mm. In this example, the fast objective has a numerical aperture (NA) of 0.8 and a focal length of 10-15 mm. The image size is 25 mm×1 mm. The colored lines show changes in vertical magnification along y direction of the plate while the black lines are vertical and straight showing no change in the horizontal magnification.

In the above-described example, the optical elements 716, 718 are a pair of x²y plates. In other implementations, the optical elements may be other types of optical components and combinations of those components, such as, without limitation, a cylindrical lens or an optical element including a cone and a cylinder.

In some implementations the optical elements may each be at least one optical component that is freeform having an optical phase function that is a two dimensional polynomial function of x and y. Each optical element may be implemented as a freeform optical element, combinations of freeform optical elements, combinations of spherical lenses, cylindrical lenses, and/or prisms, diffractive optical elements, and/or metasurfaces.

As discussed in detail above, in the example of FIGS. 7 and 8, first and second optical elements 716, 718 may be used to create the distortion, for example a trapezoidal distortion, required by the system's non-linear scanning of substrate surface 702. In some implementations, there may still be a residual aberration after this trapezoidal distortion correction. In the example of FIGS. 7 and 8 the system also includes at least one corrector element 734 in the optical path 714 that is configured to correct the residual aberration. As shown in FIG. 7, the corrector element 734 may be located at the pupil relay plane 736 between the collimator 728 and the imager 730. In FIG. 7, the corrector element 734 is depicted as a pair of position and/or tilt adjustable corrector plates positioned on opposite sides of the pupil relay plane 736, although, in other implementations, the corrector element 734 may be a single or multiple elements of various configurations positioned at the pupil relay plane 736 or elsewhere along the optical path 714. In other configurations, the corrector plate(s) can be placed between the collimator lens 728 and the Imager lens 730 even if the image of the pupil does not fall on the corrector plate.

### Folded Configuration Systems

In some embodiments, the actual layout of the optical system is relatively long, posing challenges for inclusion in a practical system. FIG. 11 presents a scale drawing of an optical system designed to reimage light in a geometry suitable for incorporating non-cylindrically symmetric plates. This configuration measures approximately 1.7 meters in length.

In some embodiments, a folded configuration, as shown in FIG. 12, may be utilized instead.

### Infidelity Detection

In some embodiments, the optical image system may further comprise a sensor for detecting infidelity and a control system configured to receive information collected by the sensor and to calculate the corrected distance between the two plates and the tilt angle of plates.

In some embodiments, the optical image system may further comprise a sensor configured to detect infidelity. This sensor is configured to monitor the quality of the image. Additionally, the system may further comprise a control system. This control system is configured to receive and analyze the data collected by the sensor. Upon processing this information, the control system is capable of calculating the necessary adjustments to optimize the system's performance. These adjustments include determining the target distance between the two plates in the optical path, as well as precisely calculating the tilt angle of each plate. Such real-time adjustments ensure that the optical system maintains optimal imaging performance by dynamically compensating for any detected infidelities, thus enhancing the overall quality and accuracy of the images produced.

### Substrate

FIG. 13 illustrates one non-limiting example of a substrate 1312 usable in the systems and methods described herein. In this example the substrate 1312 is part of a flow cell 1310 including a cover 1314 spaced apart from the substrate 1312 by spacers 1328 to define a fluid passageway 1320. The fluid passageway 1320 may be in fluid communication with an inlet 1322 and outlet 1324. As schematically illustrated in FIG. 13, the substrate 1312 may include an array of analyte discrete attachment sites 1326 for attaching nucleic acid fragments or other analyte to the substrate 1312. The discrete attachment sites 1326 may be positively charged features on the substrate 1312 separated and spaced apart by negatively charged or neutral areas of the substrate 1312. In some implementations, the number of discrete attachment sites may be arranged in two dimensional arrays that include up to millions or billions of discrete sites, spaced at pitches that may be on the order of tens or hundreds of nanometers.

The nucleic acid fragments attached to the flow cell substrate 1312 may be imaged by an optical imaging system such as the ones described above. DNA templates may be immobilized at greater than 10e7 attachment sites in an array on the flow cell substrate 1312. In this example, a nucleic acid sequencing method may involve carrying out greater than 400 sequencing cycles. In each cycle, single nucleotides (e.g., adenine, guanine, thymine, and cytosine) may be flowed across the substrate through a fluid gap and incorporated (into a growing strand) at each site where there is a complementary nucleotide base. In one approach, each of the four different nucleotides may be labeled with a different color fluorescent dye or bound by a dye-labeled antibody. In each sequencing cycle, a light source (e.g., a laser) may illuminate the spots (e.g., in series), causing the dye to emit light corresponding to the respective colors. The color emitted at each spot from one of the four dyes may be detected by a camera (e.g., a time delay integration charge-coupled device (TDI-CCD) camera or a similar camera), and the imaging system may thereby record, for each spot, the detection of a nucleotide corresponding to the detected color. Persons knowledgeable in the art will be aware of variations in sequencing methods including variations in template type (see, e.g., Huang et al., 2017, Gigascience 6:1-9; Mardis et al., 2013, Annu Rev Anal Chem 6:287-303), labeling systems (see, e.g., WO2018129214) and labeling strategies (see, e.g., U.S. Pat. No. 9,523,125).

The attachment sites 1326 on the substrate 1312 of flow cell 1310 may be fabricated by well-known lithography tools, such as 248-nm KrF (krypton fluoride), 193-nm ArF (argon-fluoride) lithography systems, or e-beam lithography systems. The arrays are typically separated with spaces between each other in ultra-high density, high density, medium density, or low density. At ultra-high density, separation is less than 250 nm. At high density, separation is 300 to 350 nm. At medium density, separation is 400 nm to 500 nm. At low density, separation is 500 nm or more. In some implementations (for example, some low density implementations) 2-dimensional patterning with photoresist is sufficient to sequester DNA nanoballs or other discrete nucleic acid samples. In some implementations (for example, some medium, high, or ultra-high density implementations), to reduce risk that discrete samples will not remain in single locations, smaller samples may be required, which may require 3-dimensional patterning for more efficient capturing of fluorescence from tagged DNA nanoballs or other tagged nucleic acid samples. In such implementations, 3-dimensional patterned well nanostructures can be developed by non-binding material as a well wall and binding material for the well bottom surface for sequestering DNA nanoballs.

### X²Y Plates System

As shown in FIGS. 7 and 8, the first and second optical elements 716 and 718 may be used to create a trapezoidal distortion to compensate for the infidelity caused by the non-linear scanning. In some embodiments, the first and second optical elements 716 and 718 may be two X²Y plates that are equally offset from the intermediate image plane as illustrated in FIG. 14.

In the embodiments, the two X²Y plates are equally offset from the intermediate image plane. The amount of trapezoidal distortion is controlled by the amplitude of the plate deformation coefficient, and the spacing between the plates. The spacing between the plates may be adjusted during the scanning process (e.g. as scanning moves closer to or further away from the center of rotation). In one example, the nominal magnification of the system may be 16.7×.

As illustrated in FIG. 15, the two X²Y plates may be inverse of each other, and the plates may be made of BK7 glass. Each of the two X²Y plates may be 0.833 mm thick and have a rectangular shape. The front surface of the first plate may be a polynomial surface and the back surface of the second plate is the same polynomial surface. The X²Y coefficient of the first or the second X²Y plates may be 1E-5 with a normalization radius of 0.833 mm.

FIGS. 16A-16C illustrate an example in which each X²Y plate is offset about 6 mm from the intermediate image. The distortion between the field edge and the field center may be 0.55%. The spot diagrams in FIG. 16B illustrate the image performance at 500 nm, 650 nm and 800 nm wavelengths, with each plot is a 10*10 um box. The circles in FIG. 16B show diffraction limited performances at the image surface.

FIGS. 17A-17C illustrate an example in which each plate is offset about 48 mm from the intermediate image plane. The distortion between the field edge and the field center is about 4%.

FIGS. 18A and 18B illustrate the polychromatic RMS wavefront error maps for the examples respectively illustrated in FIGS. 16A and 17A. FIGS. 18A and 18B illustrate the map of wavefront error over the full field, wherein X is between −0.04 mm and +0.04 mm, and Y is between −0.75 mm and +0.75 mm on the object. The rainbow bar on the right side serves as the key, which scales up to a 0.1 wave error. Any value less than 0.07 waves RMS is considered “diffraction limited.”

In one embodiment, the parameters of the lenses are listed in the table below. In the table below, the surface number is displayed in the left column, and the surface types of the lenses are presented in the second column. Surfaces 2, 4, 15, and 19 are all “Paraxial” surfaces, which represent ideal, perfect lenses. Wherein surface 2, constituting one surface of an objective lens, has a focal length of F=10 mm, both the surfaces 4 and 15 have focal length of F=300 mm, and the surface 19 has a focal length of F=167 mm.

| Surface Type | | | Comment | Radius | Thickness | | Material |
|---|---|---|---|---|---|---|---|
| 0 | OBJECT | Standard | | Infinity | 0.000 | | |
| 1 | | Standard | | Infinity | 10.000 | | |
| 2 | | Paraxial | | | 10.000 | | |
| 3 | STOP | Standard | | Infinity | 300.000 | | |
| 4 | | Paraxial | | | 300.000 | | |
| 5 | | Standard | Z-Shift | Infinity | −7.000 | | |
| 6 | (aper) | Extended Polynomial | Plate_1a | Infinity | 0.833 | | BK7 |
| 7 | (aper) | Standard | | Infinity | 0.000 | | |
| 8 | | Standard | | Infinity | 6.452 | M | |
| 9 | | Standard | Int. Image | Infinity | 0.000 | | |
| 10 | | Standard | | Infinity | 6.452 | P | |
| 11 | (aper) | Standard | Plate_1b | Infinity | 0.833 | P | BK7 |
| 12 | (aper) | Extended Polynomial | | Infinity | 0.000 | | |
| 13 | | Standard | | Infinity | 300.000 | P | |
| 14 | | Standard | | Infinity | −7.000 | P | |
| 15 | | Paraxial | | | 300.000 | | |
| 16 | | Standard | Pup. Corr | Infinity | 0.833 | | BK7 |
| 17 | | Extended Polynomial | | Infinity | 0.000 | | |
| 18 | | Standard | | Infinity | 166.667 | | |
| 19 | | Paraxial | | | 166.667 | M | |
| 20 | IMAGE | Standard | | Infinity | — | | |

### Tilted Cylindrical Lenses System

In some implementations of the system shown in FIGS. 7 and 8, the first and second optical elements 716 and 718 may be two tilted cylindrical lenses in which the tilt of the lenses may be adjusted to adjust the trapezoidal distortion applied.

As illustrated in FIG. 19, the first and second optical elements 716 and 718 may be two tilted cylindrical lenses. The pair of tilted cylindrical lenses create the trapezoidal distortion. The two titled cylindrical lenses are equally offset from the intermediate image plane. The amount of trapezoidal distortion is controlled by the focal length and tilt of the cylindrical lenses. A different focal length cylindrical lens may be placed in the pupil relay plane to correct residual aberrations. In some implementations the nominal magnification may be 16.7×.

The two cylindrical lenses may be inverse of each other. The first cylindrical lens may be a plano-concave positive lens and the second cylindrical lens may be a plano-convex negative lens. The lenses may be made of BK7 glass. Each of the two cylindrical lenses may be 2 mm thick and have a rectangular shape. The front surface of the first cylindrical lens may be curved and the back surface of the second cylindrical lens has the same curvature.

The cylindrical lenses may be modeled as “Extended Polynomial Surfaces”, with only the X² coefficient being non-zero. The X² coefficient may be −2.5E-3 with a Normalization Radius of 1.0 mm. The two cylindrical lenses are illustrated in FIGS. 20A and 20B. The two cylindrical lenses could also be true cylindrical lenses with 200 mm cylindrical radius of curvature.

In the example illustrated in FIGS. 21A-21C the lenses are tilted 2.5° relative to the intermediate image plane in opposite directions. The distortion between the field edge and the field center is about 0.51%. The spot diagrams illustrate the image performance at 500 nm, 650 nm and 800 nm wavelengths, with each plot being a 10*10 um box. The circles show diffraction limited performances at the image surface.

In the example illustrated in FIG. 22A-22C, the lenses are tilted 18° relative to the intermediate image plane in opposite directions. The distortion between the field edge and the field center is about 4%.

FIGS. 23A and 23B illustrate the polychromatic RMS wavefront error maps of the examples respectively illustrated in FIGS. 21A-21C and 22A-22C. FIGS. 18A and 18B illustrate the map of wavefront error over the full field, wherein X is between-0.04 mm and +0.04 mm, and Y is between −0.75 mm and +0.75 mm on the object. The rainbow bar on the right side serves as the key, which scales up to a 0.1 wave error. Any value less than 0.07 waves RMS is considered “diffraction limited.” FIG. 23A is directed to the example illustrated in FIG. 21A and FIG. 23B is directed to the example illustrated in FIG. 22A.

In one embodiment, the parameters of the lenses are listed in the table below. In the table below, the surface number is displayed in the left column, and the surfaced types of the lenses are presented in the second column. Wherein surface 2 constituting one surface of an objective lens has focal length of F=10 mm, both the surfaces 4 and 17 have focal length of F=300 mm, and the surface 20 has focal length of F=167 mm. This listing illustrates the used of Extended Polynomial Surfaces for the tilted lenses, a similar model using Toroidal Surfaces would illustrate true cylindrical lenses.

| Surface Type | | | Comment | Radius | Thickness | | Material |
|---|---|---|---|---|---|---|---|
| 0 | OBJECT | Standard | | Infinity | 0.000 | | |
| 1 | | Standard | | Infinity | 10.000 | | |
| 2 | | Paraxial | | | 10.000 | | |
| 3 | STOP | Standard | | Infinity | 300.000 | | |
| 4 | | Paraxial | | | 283.000 | | |
| 5 | | Coordinate Break | Element Tilt | | 0.000 | | — |
| 6 | (aper) | Extended Polynomial | 1^{st} Lens | Infinity | 2.000 | | BK7 |
| 7 | (aper) | Standard | | Infinity | −2.000 | T | |
| 8 | | Coordinate Break | Element Tilt | | 2.000 | P | — |
| 9 | | Standard | | Infinity | 15.685 | M | |
| 10 | | Standard | Intrmd. Image | Infinity | 0.000 | | |
| 11 | | Standard | | Infinity | 15.685 | P | |
| 12 | | Coordinate Break | Element Tilt | | 0.000 | | — |
| 13 | (aper) | Standard | 2^{nd} Lens | Infinity | 2.000 | P | BK7 |
| 14 | (aper) | Extended Polynomial | | Infinity | −2.000 | T | |
| 15 | | Coordinate Break | Element Tilt | | 2.000 | P | — |
| 16 | | Standard | | Infinity | 283.000 | | |
| 17 | | Paraxial | | | 300.000 | | |
| 18 | | Extended Polynomial | Corrector | Infinity | 1.000 | | BK7 |
| 19 | | Standard | | Infinity | 167.000 | | |
| 20 | | Paraxial | | | 167.017 | V | |
| 21 | IMAGE | Standard | | Infinity | — | | |

### CONCLUSION

In the systems discussed above, either the variable spacing of the pair of X²Y plates or variable tilt of the pair of tilted cylindrical lenses is used for creating adjustable trapezoidal distortions. “Cylindrical lenses” includes both true cylindrical lens surfaces and polynomial surfaces with X² shape. Both the pair of X²Y plates and the pair of tilted cylindrical lenses contribute to creating diffraction limited images, provided that the rest of the optical system is also diffraction limited over the spectral range. However, the systems discussed here represent simple examples from a larger set of solutions. Many details within these systems can be varied while still maintaining good image quality.

While the principles of the disclosure have been described above in connection with specific examples of flow cells, systems, and methods, it is to be understood that this description is made only by way of example and not as limitation on the scope of the present inventions. Examples were chosen and described in order to explain the principles of the invention and practical applications to enable others skilled in the art to utilize the invention in various implementations and with various modifications, as are suited to a particular use contemplated. It will be appreciated that the description is intended to cover modifications and equivalents.

1. An optical analysis method comprising:
(a) rotating a substrate relative to an objective of a first optical assembly resulting in a non-linear scanning of the objective relative to a surface of the substrate, wherein the surface of the substrate comprises an array of discrete analyte binding sites each configured to immobilize an analyte;
(b) using the objective to collect radiation associated with the discrete analyte binding sites;
(c) using the first optical assembly to form an intermediate image plane positioned between the first optical assembly and a detector;
(d) using a first optical element positioned in an optical path between the objective and the intermediate image plane and a second optical element positioned in an optical path between the intermediate image plane and the detector to introduce a distortion to compensate for the non-linear scanning of the objective relative to the surface of the substrate.

2. The optical analysis method of claim 1 further comprising using a second optical assembly to form an image plane at the detector.

3. The optical analysis method of claim 2 wherein the second optical assembly comprises an imaging lens.

4. The optical analysis method of claim 2 wherein using the first optical assembly to form the intermediate image plane comprises using the first optical assembly to focus the collected radiation to form an intermediate image at the first intermediate image plane, and wherein using the second optical assembly to form the image plane at the detector comprises using the second optical assembly to focus the collected radiation to form an image at the image plane at the detector.

5. The optical analysis method of claim 4 further comprising using at least one corrector optical element in the optical path between the second optical element and the detector to correct a residual aberration.

6. The optical analysis method of claim 5 further comprising using a third optical assembly to form a pupil relay plane, wherein the at least one corrector optical element is located at or near the pupil relay plane.

7. The optical analysis method of claim 6 wherein the third optical assembly comprises a collimator.

8. The optical analysis method of claim 4 wherein the detector comprises a plurality of rows of detector pixels in a rectangular array.

9. The optical analysis method of claim 8 wherein using the first optical element and the second optical element to introduce the distortion comprises using the first and second optical elements to apply a trapezoidal distortion to compensate for the non-linear scanning.

10. The optical analysis method of claim 9 wherein the detector is a Time Delay Integration (TDI) sensor.

11. The optical analysis method of claim 8 wherein rotating the substrate results in a differential angular velocity between analyte binding sites that are relatively further away from a rotational axis of the substrate compared to binding sites that are relatively closer to the rotational axis, wherein the differential angular velocity is associated with an anisotropic distortion.

12. The optical analysis method of claim 8 wherein the optical analysis distinguishes discrete radiation events at the analyte binding sites with the analyte binding sites arranged in an array with an analyte binding site center to center spacing of 1.2 μm or less.

13. The optical analysis method of claim 2 wherein the first optical element comprises at least one optical element selected from the group consisting of an x²y plate, an x² plate, a cylindrical lens, and a conical lens.

14. The optical analysis method of claim 13 wherein the second optical element comprises at least one optical element selected from the group consisting of an x²y plate, an x² plate, a cylindrical lens, and a conical lens.

15. The optical analysis method of claim 14 wherein the second optical element is implemented as a freeform optical element, combinations of freeform optical elements, combinations of spherical lenses, cylindrical lenses and prisms, diffractive optical elements, and/or metasurfaces.

16. The optical analysis method of claim 2 further comprising adjusting at least one of a position and an orientation of at least one of the first optical element and the second optical element.

17. The optical analysis method of claim 16 wherein the non-linear scanning of the objective relative to the surface of the substrate comprises a spiral scanning.

18. The optical analysis method of claim 17 wherein at least one of the position and the orientation of the at least one of the first optical element and the second optical element is adjusted during the spiral scanning.

19. The optical analysis method of claim 18 wherein the at least one of the position and the orientation of the at least one of the first optical element and the second optical element is adjusted in response to an increase or a decrease of a scan radius of the spiral scanning.

20. The optical analysis method of claim 18 further comprising using at least one corrector optical element in the optical path between the second optical element and the detector to correct a residual aberration; and adjusting at least one of the position and the orientation of the corrector optical element in response to an increase or a decrease of a scan radius of the spiral scanning.

21. The optical analysis method of claim 2 wherein the surface of the substrate is an interior surface of a flow cell.
